(19) United States
(12) Patent Application Publication
(10) Pub. No.: US 2006/0048084 A1
(43) Pub. Date: Mar. 2, 2006

(54) System and method for repairing timing violations

(76) Inventors: C. Alva Barney, Fort Collins, CO (US); Erick H. Martin, Fort Collins, CO (US); Scott R. Grange, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/928,783

(22) Filed: Aug. 27, 2004

(51) Int. Cl. G06F 17/50

(52) U.S. Cl. 716/6; 716/2

(57) ABSTRACT

One disclosed method for repairing min-time timing violations comprises receiving a circuit design to analyze, analyzing the circuit design to determine if a min-time timing violation is present in the circuit design, and fixing a determined min-time timing violation by replacing an appropriate element of the circuit design with a de-raced element.

### FIELD OF THE INVENTION

This invention relates in general to circuit design and more particularly to a system and method for repairing timing violations in circuits.

### DESCRIPTION OF RELATED ART

In designing an integrated circuit (IC), designers often begin by creating a behavioral level model of a circuit that describes a given design. The behavioral level basically involves correctly modeling the functionality of the circuit without regard to the exact clock-cycle by clock-cycle behavior. After a behavioral level model is developed, the behavioral level model is usually evolved into a register-transfer level (RTL) model that represents the microarchitecture of the circuit design.

The RTL model is a model of the designed circuit in which the operations of a sequential circuit are described as synchronous transfers between functional units. The logic functions are usually synchronized to a clock. After the RTL model is completed, the RTL model is converted into a combination of sequential elements and combinational logic cells through various synthesis and translation tools. The synthesis tools use some sort of cell library that includes basic logic cells, such as a nand, nor, invert, buffer, mux, xor, and the like. The cell library also includes various state elements, such as flip flops or latches. The synthesis tools synthesize or map the functionality described in the RTL into the logic and state elements available in the cell library.

After the RTL level has been synthesized into the various logic and state elements, the synthesized design undergoes a layout process using place-and-route tools so that the integrated circuit may be manufactured. The layout process has two primary functions: 1) determining the positions or placement of the cells on a layout surface, and 2) interconnecting the components with wiring, or routing. Thus, during layout, two problems are addressed: the placement of the different cells, and the routing of their interconnection. Improper or imprecise routing of the interconnection and poor non-optimal logic design can cause problems associated with the timing required for a signal to reach its destination point. These problems associated with timing may cause minimum (min) timing violations. When a signal arrives at the end of its path too early, a min-time timing violation will occur.

### BRIEF SUMMARY OF THE INVENTION

According to at least one embodiment, a method for repairing timing violations is provided. The method comprises receiving a circuit design to analyze, analyzing the circuit design to determine if a min-time timing violation is present in the circuit design, and fixing a min-time timing violation by replacing an appropriate element of the circuit design with a de-raced element.

According to at least one embodiment, a system for repairing timing violations is provided. The system comprises a means for analyzing a circuit for the presence of at least one timing violation, a means for identifying an element to replace with a de-raced element to repair the timing violation, and a means for replacing the identified element with the de-raced element.

According to at least one embodiment, a computer program product is provided having a computer readable medium having computer program logic recorded thereon for repairing timing violations. The computer program product comprises code for analyzing a circuit for the presence of at least one timing violation, code for identifying at least one endpoint corresponding to the timing violation, and code for identifying at least one circuit element associated with the endpoint wherein the element can be replaced to repair the timing violation.

### BRIEF DESCRIPTION OF THE DRAWINGS

FIG. 1 illustrates a clock signal and a block diagram of a circuit depicting how a timing violation may occur;

FIG. 2A is a flowchart illustrating steps executed for repairing timing violations, according to one embodiment;

FIG. 2B illustrates an example of an element containing multiple endpoints that may be used in determining if an endpoint is a qualifying or non-qualifying endpoint;

FIG. 3 illustrates block diagrams of circuits with timing violations and various solutions to the timing violations;

FIGS. 4A-4B illustrate a circuit with a min-time timing violation that is repaired according to one embodiment for repairing min-time timing violations;

FIGS. 5A-5B illustrate another circuit with a min-time timing violation that is repaired according to another embodiment;

FIG. 6 is an illustration of a general architecture of a system of an embodiment for repairing timing violations; and

FIG. 7 depicts a block diagram of a computer system which is adapted to use an embodiment for repairing timing violations.

### DETAILED DESCRIPTION

Circuits comprise a plurality of elements whereby signals travel various paths from a start point of an element to an end point of an element. Issues may arise if the timing required for a signal to travel from a start point of one element to an end point of another element violates a design objective, whereby a design objective may be a min-time requirement or a max-time requirement (i.e. is not within an expected min and max time). A min-time requirement may specify the minimum amount of time that should pass before a signal arrives at the next point and a max-time requirement may specify the maximum amount of time that should pass before a signal arrives at the next point. Thus, when a signal leaves a start point of one element and is headed to an end point of another element, a minimum amount of time or amount of delay is often required and should pass before the signal arrives at the end point or next element. Without this minimum amount of delay, there may exist a min-time timing violation or a min-time requirement violation whereby the value in one state element can be inadvertently overwritten before it has a chance to propagate, and ultimately, an error occurs as a result of the min-time timing violation. Thus, a min-time timing violation occurs when a signal arrives at the end of a timing path or an endpoint too early. As opposed to a min-time timing violation, a max-time timing violation occurs when a signal arrives at the end of a timing path too late. A timing path is a path that may run from the clock port of a preceding state element to an input pin of the next state element. The timing path may be a straight path from one element to the next element or the timing path may contain some logic that exists between the clock port of one element and the input pin of the next element. Generally, an endpoint is an input pin, such as a data pin, an enable pin, a reset pin, and the like, on a circuit element, such as a state element, that serves as the endpoint of a timing path. Accordingly, when a signal reaches an endpoint too early or too late, a timing violation has occurred.

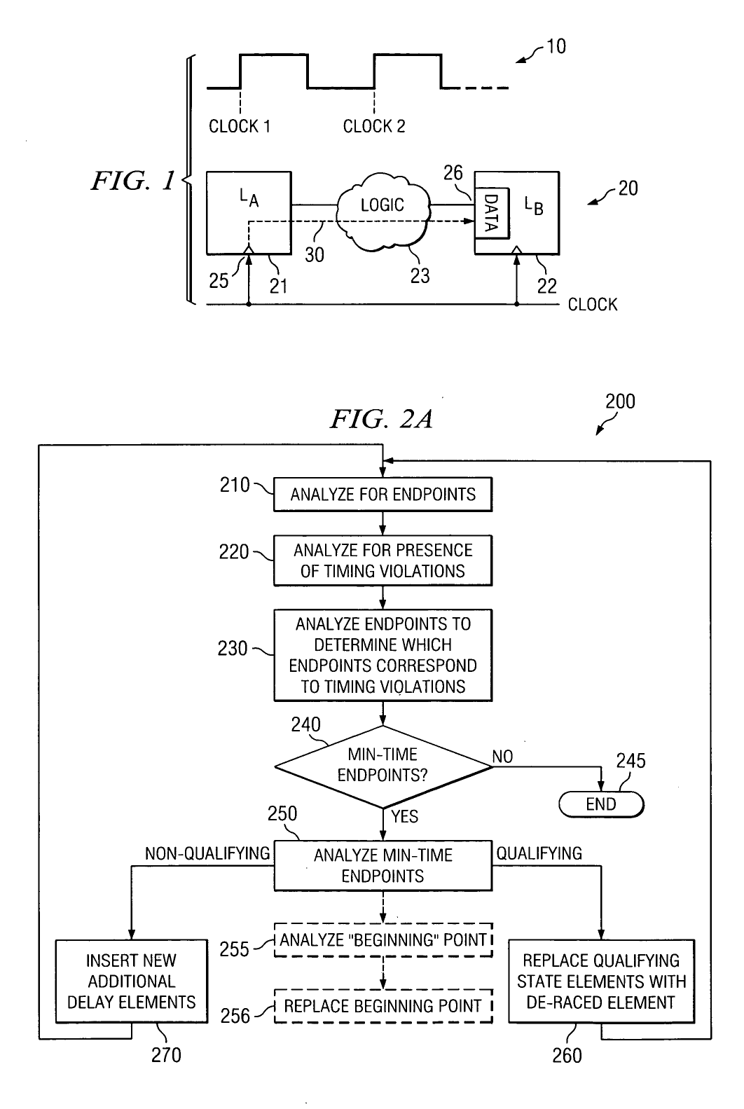

FIG. 1 depicts a clock signal and a block diagram of a circuit illustrating how a min-time and max-time timing violation may occur. Clock signal 10 includes two positive transition edges shown as clock 1 and clock 2. Clock 1 is a first positive going transition edge of clock signal 10 and clock 2 is a second positive going transition edge of clock signal 10.

In addition to clock signal 10, FIG. 1 also illustrates circuit 20. Circuit 20 includes latch A 21, latch B 22, and logic 23. A timing path is also illustrated by the path 30 from the beginning point 25 to the ending point 26. Beginning point 25 may be a clock pin to latch A 21 and ending point 26 may be a data input pin to latch B 22. A first value may be provided to logic 23 at the time of clock 1 to determine the value that is passed to data input pin 26, and another value may be provided to logic 23 at the time of clock 2 to determine another value passed to data input pin 26. If the first value is produced too late from logic 23, after clock 1, then an incorrect value may ultimately be supplied to data input pin 26 when the data is captured at clock 2. When this occurs, a max-time timing violation has occurred. If the first value is produced too early by logic 23 with respect to clock 1, then an incorrect value may ultimately be captured at data input pin 26 on the clock 1 transition at latch B 22. When this occurs, a min-time timing violation has occurred and the data has been corrupted.

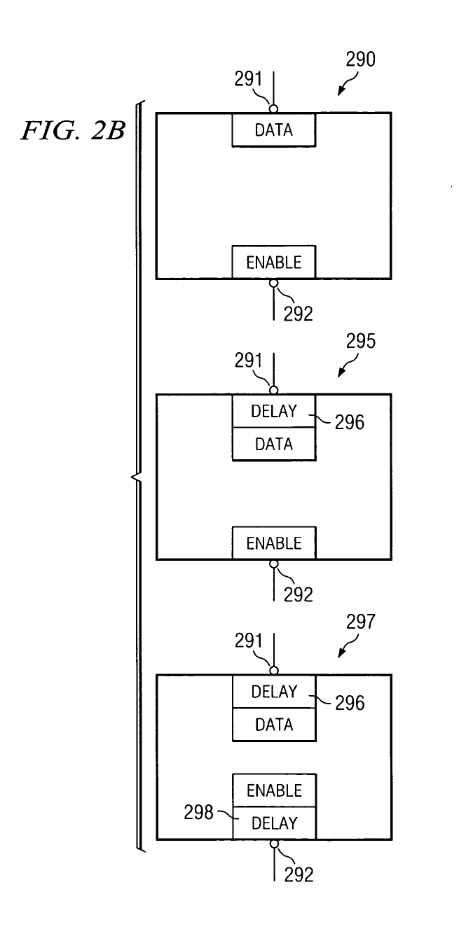

FIG. 2A depicts a flowchart illustrating an operational flow 200 for repairing timing violations, such as a min-time timing violation, according to one embodiment. In block 210, a circuit that may be comprised of a plurality of state elements, such as an integrated circuit, is analyzed for the presence of endpoints. For example, a circuit may be analyzed for endpoints with the use of SYNOPSIS™ INC's PrimeTime® or PathMill® or CADENCE™ DESIGN SYSTEMS, INC.'s CTE®. After the circuit is analyzed for endpoints in block 210, the circuit is analyzed for the presence of timing violations in block 220. For example, the timing violations may be identified with the use of SYNOPSIS™ INC's PrimeTime® or PathMill® or CADENCE™ DESIGN SYSTEMS, INC.'s CTE®. After analyzing for timing violations, the endpoints are analyzed in block 230 to determine which endpoints, if any, correspond to the timing violations that may have been identified in block 220. Accordingly, any endpoints, such as endpoints associated with state elements, may be associated with a min-time timing violation and identified as min-time endpoints. These endpoints that may be associated with a min-time timing violation and identified as a min-time endpoint are the endpoints that receive a signal too early, such as a signal that arrives at the end of a timing path too early.

After flow 200 determines which endpoints correspond with timing violations, such as min-time timing violations, in block 230, flow 200 proceeds to query block 240. In query block 240, a query is performed to determine if any of the endpoints corresponding to timing violations are endpoints that correspond to min-time timing violations and thus min-time endpoints. If no min-time endpoints are located, then flow 200 proceeds to end block 245 where flow 200 may end. However, if a min-time endpoint has been located, then flow 200 proceeds on to block 250. In block 250, the min-time endpoints or the endpoints associated with the min-time timing violations are examined. The min-time endpoints are examined to determine if any of the min-time endpoints are a “qualifying” endpoint, as described further below.

In block 250, the min-time endpoints are identified as either a qualifying or non-qualifying endpoint. Accordingly, block 250 identifies the element, such as a state element, that was determined to be associated with the endpoint as either a qualifying element or non-qualifying element depending on how the associated min-time endpoint is identified. For example, if endpoint A is associated with state element 1 and endpoint B is associated with state element 2, then block 250 may analyze endpoints A and B and may identify state elements 1 and 2 according to how endpoints A and B are identified. Thus, if endpoint A is identified as qualifying, then state element 1 may also be identified as qualifying, and if endpoint B is identified as non-qualifying, then state element 2 may also be identified as non-qualifying.

A status of “qualifying” or “non-qualifying” may correspond to various conditions of the endpoint wherein a qualifying endpoint may satisfy a set of conditions. In one embodiment, a qualifying endpoint is an endpoint which: (a) is an endpoint for a min-time timing violation, (b) contains a sufficient max-time margin so that the insertion of a new element, such as a de-raced latch, will not introduce a new max-time failure, and (c) is not disqualified by other miscellaneous issues, such as a circumstance in which the endpoint corresponds to an element whereby no other device fits or satisfies the exact requirements or characteristics associated with that state element, such as the element illustrated in FIG. 2B. Thus, if an endpoint satisfied the conditions established by conditions (a), (b), and (c), then that particular endpoint would be identified as a qualifying endpoint.

FIG. 2B illustrates state element 290 that includes data input pin 291 and enable input pin 292. Data input pin 291 is an endpoint for a min-time timing violation and contains a sufficient max-time margin so that the insertion of a new element, such as a de-raced latch, will not introduce a new max-time failure. Thus, data input pin 291 seems to be a “qualifying” endpoint. Enable input pin 292 is also an endpoint of a min-time timing violation, but enable input pin 292 does not contains a sufficient max-time margin. Thus, the insertion of a new state element, such as de-raced latch 297, where both inputs (data input 291 and enable input 292) include a delay element, illustrated by delay elements 296 and 298, will introduce a new max-time failure on enable input pin 292. Accordingly, enable input pin 292 is not a “qualifying” endpoint. Thus, in order to fix the timing violations associated with state element 290, a replacement state element, such as replacement element 295, must be an element that includes delay element 296 for data input pin 291 and no delay on enable input pin 292. However, if there is no state element that satisfies the exact requirements illustrated by replacement element 295, then data input pin 291 will be given a status of “non-qualifying.” Data input pin 291 will be labeled as “non-qualifying” because although data input pin 291 is an endpoint for a min-time timing violation and contains a sufficient max-time margin, data input pin 291 is an endpoint that corresponds to an element, element 290, whereby no other device fits or satisfies the exact requirements associated with that state element. As illustrated by FIG. 2B, the qualifying or non-qualifying status of an endpoint may be affected by other endpoints associated with the same state element.

After block 250, flow 200 proceeds to either block 260 or block 270 depending on how the endpoint and corresponding element is identified in block 250. After blocks 260 and 270, flow 200 may then flow back to block 210 to begin further analyzation for endpoints. If an endpoint is identified as qualifying in block 250, then flow 200 proceeds on to block 260. However, if an endpoint is labeled as non-qualifying in block 250, then flow 200 proceeds to block 270.

In block 260, the qualifying elements, such as a qualifying state element, corresponding to the qualifying endpoints are replaced with de-raced elements in order to remedy the min-time timing violation. A de-raced element is a functional element, such as a state element, and a delay element that is integrated therewith. The functional element of the de-raced element may have the same functionality as the qualifying state element. For example, if a first latch were identified as a qualifying latch, then this first latch may be replaced with a de-raced element that would include a second latch and some type of delay element integrated with the second latch.

The integrated delay element operates to slow down or delay the respective signal entering the qualifying endpoint of the qualifying element so that the signal will no longer arrive at the endpoint too early. The min-time timing violation may be repaired by slowing down or delaying the signal with the integrated delay element. By curing the min-time timing violation, the de-raced element is basically holding data constant at a state input for a certain time period after a clock edge so that the capturing state element can close. As such, the min-time timing violation is cured by replacing the qualifying element without having to add any additional elements. For example, if a latch is identified as a qualifying latch, then the latch may be replaced with a de-raced latch that will operate to insert a needed delay to cure the min-time timing violation.

In addition to the de-raced element having a delay element integrated with the state element, the de-raced element may fit into the same footprint as the qualifying element so that there is minimal to no disturbance to the layout of a circuit. Thus, in one embodiment, the de-raced element may be a one-for-one replacement with respect to size or area occupied by the qualifying element, and there may be no need for additional area or power, as the de-raced element may fit the same foot print as the qualifying element. Accordingly, the replacing of the qualifying element with the similar sized de-raced element helps to provide a low-impact method for repairing the min-time timing violations. However, in other embodiments, the de-raced element may not be a one-for-one replacement with respect to the size and area occupied by the qualifying element.

In block 270, the min-time timing violations associated with non-qualifying state elements (remaining min-time timing violations) may be remedied through the operation of another min-time repairing algorithm, such as those available in commercial synthesis tools like SYNOPSIS™ INC's Physical Compiler®, CADENCE™ DESIGN SYSTEMS, INC.'s Physically Knowledgeable Synthesis (PKS), and the like. However, these available synthesis tools do not analyze circuits for qualifying endpoints and are unable to repair min-time timing violations associated with qualifying endpoints by replacing the qualifying elements with a de-raced element. Accordingly, these synthesis tools may be used to repair the min-time timing violations that are unable to be repaired by present embodiments which replace the qualifying state element with a de-raced element. These synthesis tools may have integrated timing capabilities and the ability to insert new independent delay elements, such as delay buffers. These new delay buffers may be inserted into the circuit as needed to fix the remaining min-time timing violations and may be used for all min-time timing violations that occur at a non-qualifying endpoint. These remaining min-time violations are typically a small subset of the initial min-time timing violations. However, the insertion of these new delay buffers is undesirable because the additional delay buffers require additional area and power as opposed to embodiments described herein whereby using a de-raced element to fix a min-time timing violation often does not require additional area or power. Thus, it is desirable to only use these available synthesis tools to repair min-time timing violations that can not be remedied through the use of a de-raced element. Accordingly, operation of these available synthesis tools to insert new independent delay buffers is undesirable and should be used, only as needed, to repair min-time timing violations that can not be repaired with the use of a de-raced state element according to embodiments discussed herein.

In an alternative embodiment, flow 200 may be configured to include blocks 255 and 256 instead of blocks 250 and 260. In such an embodiment, flow 200 proceeds to block 255 after block 250. In block 255, a beginning point is identified. Generally, a beginning point is a pin, such as an output pin, a data pin, and the like, on a circuit element that serves as the beginning point of a timing path whose endpoint is a min-time endpoint. After, block 255, flow 200 proceeds to block 256. In block 256, the circuit element associated with the beginning point (beginning point element) identified in block 255 is replaced with a de-raced element. However, this process of replacing a beginning point element with a de-raced element may not operate in all circuit designs. For example, if the output of a beginning point element is passed on to several timing paths in addition to a timing path that includes a min-time endpoint, then the replacing of the beginning point element with a de-raced element may affect the remaining timing paths and may therefore be inappropriate for that particular circuit design.

The method illustrated in FIG. 2A can be used for repairing timing violations in several different types of circuit configurations. For example, flow 200 can be used to repair timing violations in integrated circuits, circuit designs that have not yet been physically implemented, and the like.

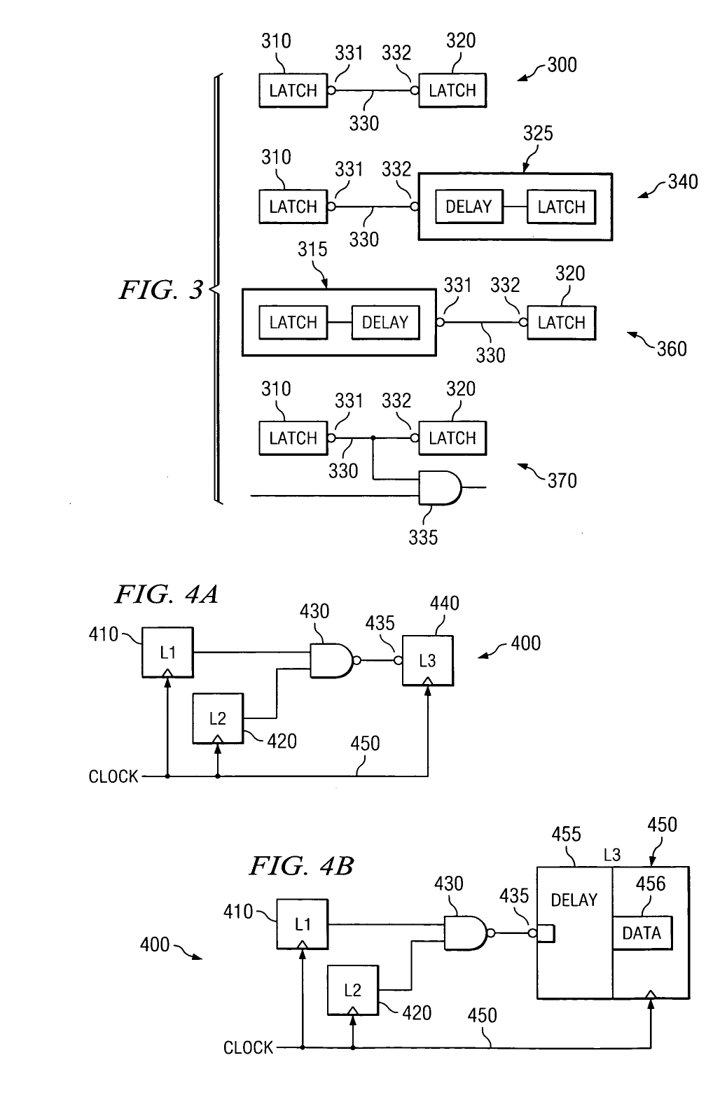

FIG. 3 illustrates some block diagrams of circuits with timing violations and some solutions to those timing violations, such as that described by flow 200 of FIG. 2. Circuit 300 includes latch 310 and latch 320. Timing path 330 indicates the path that a signal travels from latch 310 to latch 320. In addition, timing path 330 includes beginning point 331, such as a clock pin to a latch or flip-flop or an input port to a design, and endpoint 332, such as a data input to a latch or flip-flop or a data output to a design. Circuit 300 may have a timing violation, such as a min-time timing violation, associated with timing path 330. Circuits 340 and 360 illustrate two possible solutions to the min-time timing violation present in circuit 300. Circuit 340 illustrates the circuit of 300 wherein latch 320 is replaced with de-raced latch 325, and circuit 360 illustrates the circuit of 300 wherein the beginning point element, latch 310, is replaced with de-raced element 315. However, as discussed above with respect to block 256 of FIG. 2, the solution illustrated by circuit 360 may not be appropriate in all circuits. For example, circuit 370 illustrates a situation whereby the solution implemented in circuit 360 is not appropriate. Circuit 370 illustrates circuit 300 wherein the output from latch 310 is also used as an input to AND gate 335. Thus, the solution of circuit 360 wherein de-raced element 315 was implemented would not be ideal to circuit 370 because the delay introduced by de-raced element 315 may cause problems as the output of latch 310 of circuit 370 is also input to AND gate 335.

FIGS. 4A-4B illustrate an example of how a circuit with a min-time timing violation may be repaired. FIG. 4A illustrates an example circuit 400 including a first latch 410, a second latch 420, a NAND gate 430, and a third latch 440. A clock signal 450 is also present. Upon analyzing circuit 400, a min-time timing violation may be detected in the path from the first latch 410 and the second latch 420 to the third latch 440. As such, endpoint 435 may be detected as a min-time endpoint, and the third latch 440 may be identified as a min-time state element that is associated with the min-time endpoint 435. In circuit 400, endpoint 435 may be identified as a qualifying endpoint if endpoint 435 satisfied a set of conditions, such as those described above. If endpoint 435 satisfies the relevant conditions, then the third latch 440 may be identified as a qualifying state element. Accordingly, the min-time timing violation present in circuit 400 can be repaired by replacing the third latch 440 with a de-raced state element, as described above.

FIG. 4B illustrates the circuit of FIG. 4A whereby the min-time timing violation present in FIG. 4A has been repaired. The circuit of FIG. 4B illustrates the same elements as FIG. 4A except that FIG. 4B includes de-raced latch 450 in place of latch 440. De-raced latch 450 is a latch with delay element 455 integrated into the state element. Delay element 455 operates to delay inputs coming from endpoint 435 so that data signals going to data input point 456 will be delayed by delay element 455 before they reach input point 456. Thus, the third latch 450 of FIG. 4B replaced the third latch 440 of FIG. 4A in order to repair the min-time timing violation. Accordingly, FIG. 4B illustrates how min-time timing violations may be remedied by replacing a qualifying state element with a de-raced state element.

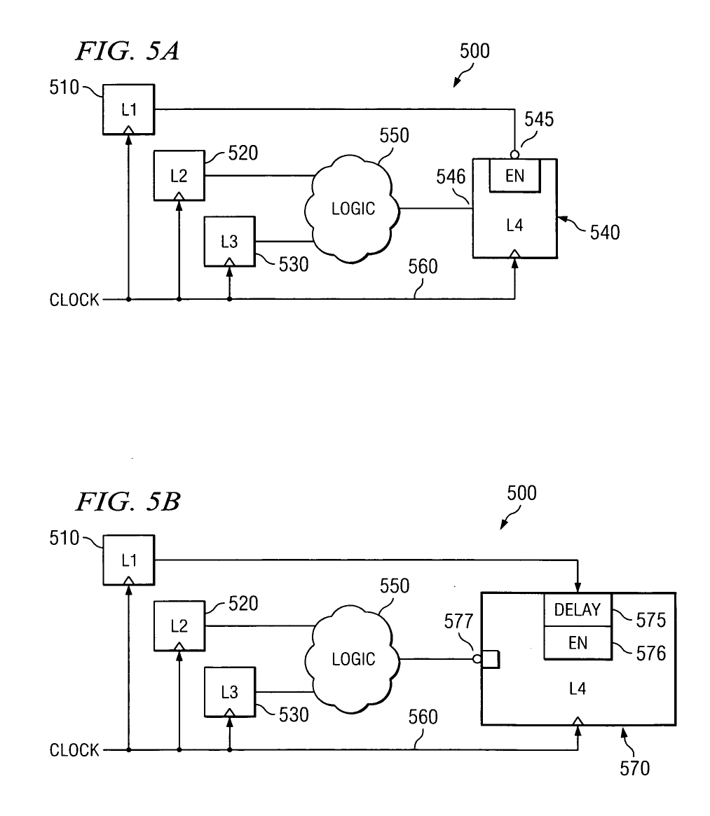

FIG. 5A illustrates another example circuit including a min-time timing violation, and FIG. 5B illustrates the circuit of FIG. 5A wherein the min-time timing violation has been repaired. FIG. 5A illustrates a circuit 500 including a first latch 510, a second latch 520, a third latch 530, a fourth latch 540 with enable pin 545 and input pin 546, logic 550, and a clock signal 560. Circuit 500 may be analyzed such that a min-time timing violation is detected in the path from the first latch 510 to the enable pin 545 of the fourth latch 540. As such, the enable pin 545 may also be identified as a min-time endpoint. Thus, the fourth latch 540 may be identified as a min-time state element that is associated with the min-time endpoint or enable pin 545. Accordingly, a delay may be added to min-time endpoint 545 without adding a delay to the various other endpoints, such as endpoint 546. Thus, all inputs of a min-time timing violation device need not be delayed, but rather can be selectively delayed on a per endpoint basis.

In the process of repairing the min-time timing violation, endpoint/enable pin 545 may be analyzed to determine if it is a qualifying endpoint. In order to determine if endpoint/enable pin 545 is a qualifying endpoint, a check may be performed to determine if endpoint 545 satisfies a set of conditions. Thus, a check may be performed on endpoint/enable pin 545 to determine: (a) if the endpoint is an endpoint for a min-time violation, (b) if the endpoint contains a sufficient max-time margin so that the insertion of a de-raced state element will not introduce a new max-time failure, and (c) if the endpoint will be disqualified by some other miscellaneous issue, such as the lack of a device/state element that can satisfy the exact requirements associated with the state element associated with the particular endpoint in question.

The results of such a check may reveal that endpoint/enable pin 545 is an endpoint for a min-time timing violation illustrated by the min-time timing violation associated with the path from the first latch 510 to the fourth latch 540 where enable pin 545 is the endpoint of that min-time timing violation. In addition, a sufficient max-time margin may be identified, and the fourth latch 540 may be identified as a latch that may easily be replaced by another latch/device, as the fourth latch 540 does not include any irregular or extraordinary requirements. Thus, endpoint/enable pin 545 and fourth latch 540 may be identified, respectively, as a qualifying endpoint and a corresponding qualifying state element.

As the fourth latch 540 has been identified as a qualifying state element, it may be replaced by a de-raced latch that includes an integrated delay element that slows down or delays a signal, such as a signal traveling on the min-time path from the first latch 510 to the fourth latch 540, in order to repair the min-time timing violation, as illustrated in FIG. 5B.

FIG. 5B illustrates the circuit of FIG. 5A where the fourth latch 540 of FIG. 5A has been replaced with de-raced latch 570. De-raced latch 570 includes a delay element 575 that is integrated into de-raced latch 570. Delay element 575 of FIG. 5B is only at the enable input point 576 of latch 570 and does not effect the data input point 577. As such, delay elements that are integrated into the de-raced circuit elements can be selectively added for any combination of one or more endpoints of a min-time timing violation device. In addition, the amount of delay associated with the delay elements at each endpoint of the min-time timing violation device may differ. For example, if a de-raced latch were utilized to repair a min-time timing violation and it included two delay elements for two different endpoints, then the amount of time for the first delay element may comprise one value while the amount of time delay for the second delay element comprises a different value. Thus, various embodiments may be arranged to handle multiple ports and inputs, such as data and/or enable inputs regardless of the mix of timing situations or min-time timing violations. For example, FIG. 2B illustrates how a delay element may be integrated into a state element, such as a latch, and operate to only delay inputs at a data input, as illustrated by delay element 255 at input point 256, and FIG. 3B illustrates how a delay element may operate to only delay inputs at an enable input, as illustrated by delay element 375 at enable input point 376. However, the depictions of FIGS. 2B and 3B are for illustration only, and in alternative embodiments, de-raced elements may be arranged such that delay elements may operate to delay any one of or combination of various inputs, such as a data input, an enable input, a reset input, and the like.

With the delay element 575 integrated into de-raced latch 570, min-time timing violations may be repaired without the need for additional components or cells, such as delay buffers. In addition, de-raced latch 570 may fit into the same basic footprint or area that was occupied by fourth latch 540 so that there may be no added area, congestion, or power resulting from replacing latch 540 with de-raced latch 570.

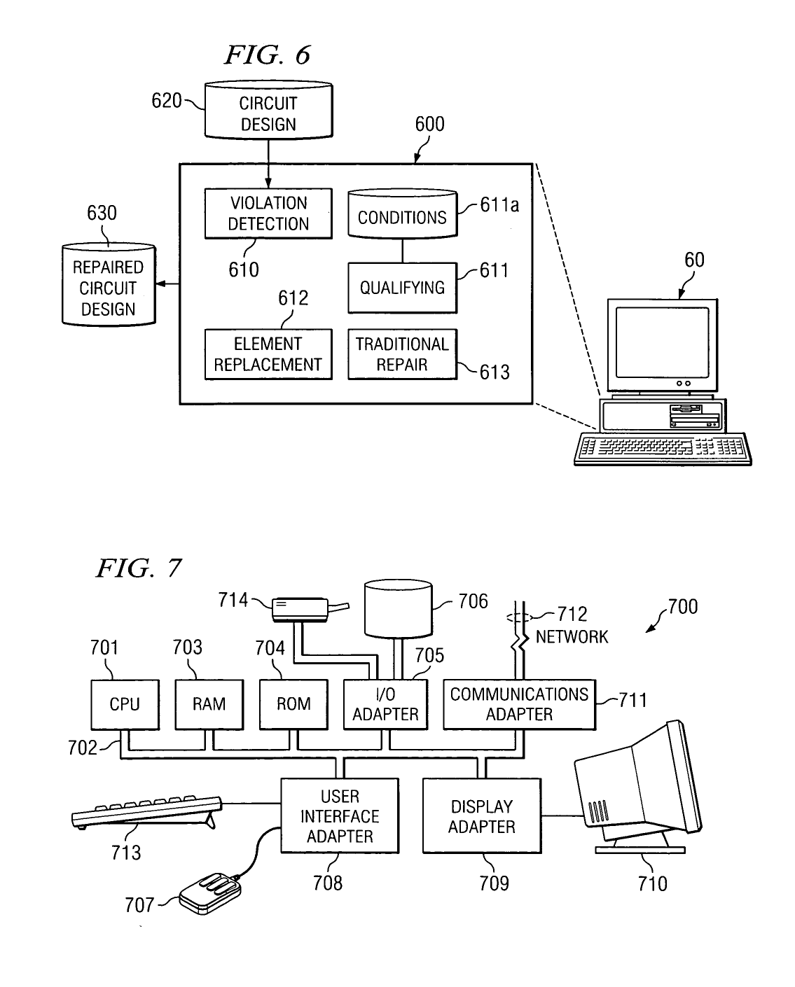

FIG. 6 is a diagram illustrating timing analysis environment 600 implemented on computer 60 for repairing timing violations, such as a min-time timing violation, according to an embodiment of the present invention. In this example, timing analysis environment 600 represents one application running on computer 60. Of course, in other embodiments, the various functional operations described herein may be distributed across a plurality of applications executing on computer 60. In addition to timing analysis environment 600, computer 60 may include an operating system, a computer's coordinating program that is built on the instruction set for a processor or a microprocessor, and the hardware that performs the logic operations and manages the data movement of the computer.

In one embodiment, timing analysis environment 600 includes violation detection module 610, qualifying endpoint and/or qualifying element detection module 611, element replacement module 612, and traditional timing repair module 613. Timing analysis environment 600 is advantageous as it may function to repair timing violations in such a manner as not to disturb the layout of the circuit under analysis.

Violation detection module 610 analyzes circuits or designs for the presence of timing violations, such as a min-time timing violation. For example, timing analysis environment 600 may receive circuit design 620 from an external source, such as a circuit designer, another program that creates circuit designs, some type of storage medium, a network, and the like. Thus, violation detection module 610 detects the presence of a min-time timing violation in a given circuit design under analysis. Thus, violation detection module 610 analyzes circuit design 620 for the presence of a timing violation. If a timing violation is detected, then violation detection module 610 flags the endpoint or timing path associated with any detected violations to help in repairing such violation.

Qualifying endpoint and/or qualifying element detection module 611 operates to detect the presence of qualifying endpoints and corresponding qualifying elements that are associated with the qualifying endpoints. In one embodiment, detection module 611 detects qualifying endpoints and qualifying elements by analyzing endpoints and elements and determining if the endpoints and elements satisfy a specified set of conditions, wherein the conditions may be stored in a separate file or database, such as database 611a. For example, an endpoint and corresponding element may be identified as qualifying if the following conditions are satisfied: (a) the endpoint is an endpoint for a min-time timing violation, (b) the endpoint contains a sufficient max-time margin so that the insertion of a de-raced latch will not introduce a new max-time failure, and (c) the endpoint is not associated with a state element that is arranged in a manner whereby no other device or element fits or satisfies the exact requirements of that state element.

Element replacement module 612 operates to replace elements that were previously identified as a qualifying element by qualifying endpoint and/or qualifying element detection module 611. Thus, elements that are identified as a qualifying element are replaced by a de-raced element wherein the de-raced element is functionally the same element as the qualifying element with the addition of a delay element integrated therein.

Traditional timing repair module 613 operates to repair all remaining timing violations, such as remaining min-time timing violations, that are associated with non-qualifying elements. For example, traditional timing repair module 613 repairs the remaining timing violations, such as any remaining min-time timing violations, by inserting additional elements or cells, such as delay buffers, into the timing paths associated with the min-time timing violations so that the additional delay buffer can repair the min-time timing violations. In one embodiment, traditional timing repair module 613 may also operate to interact with a user to receive input from the user as the user selects the appropriate elements to insert for repairing the remaining timing violations, such as a non-qualifying min-time timing violation.

After timing analysis environment 600 has analyzed and repaired a circuit design, such as circuit design 620, timing analysis environment 600 outputs repaired circuit design 630. Repaired circuit design 630 is circuit design 620 after the timing violations have been repaired by timing analysis environment 600. For example, circuit design 620 may have a min-time timing violation associated with a first latch, and timing analysis environment 600 may repair this min-time timing violation by replacing this first latch with a de-raced element. Thus, repaired circuit design 630 would in effect be the circuit of circuit design 620 where the first latch has been replaced with a de-raced element.

In alternative embodiments, timing analysis environment 600 may be configured to include more or less modules than modules 610, 611, 612, and 613, of FIG. 6. In addition, the various modules may be combined to make up fewer than the four separate modules, 610, 611, 612, and 613 illustrated in FIG. 6. In other embodiments, the various modules may be integrated into and operated with various commercial synthesis tools. For example, in one embodiment, element replacement module 612 may be embedded into a standard physical synthesis tool using the internal timing engine of a standard physical synthesis tool, such as SYNOPSIS™ INC's Physical Compiler®, CADENCE™ DESIGN SYSTEMS, INC.'s Physically Knowledgeable Synthesis (PKS), and the like. In such an embodiment, element replacement module 612 may be called from the standard physical synthesis tool without having to leave the standard physical synthesis tool so that the embodiment would run as an integrated flow so that a circuit designer will not have to start and stop between the present invention and the standard physical synthesis tool.

When timing analysis environment 600 is implemented in software, the elements of the embodiments are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” or “computer readable medium” may include any medium that can store and/or transfer information. Examples of the processor (or “computer”) readable medium include an electronic circuit, a semiconductor memory device, a ROM, a flash memory, an erasable ROM (EROM), a random access memory (RAM), a floppy diskette, a compact disk CD-ROM, an optical disk, a hard disk, a fiber optic medium, a radio frequency (RF) link, etcetera. The computer data signal may include any signal that can propagate over a transmission medium such as electronic network channels, optical fibers, air, electromagnetic, RF links, etcetera. The code segments may be downloaded via computer networks such as the Internet, Intranet, WAN, LAN, etcetera.

FIG. 7 illustrates computer system 700 adapted to use embodiments for detecting and repairing timing violations, such as computer 60 of FIG. 6, e.g. storing and/or executing software associated with the embodiments. Central processing unit (CPU) 701 is coupled to system bus 702. The CPU 701 may be any general purpose CPU. Embodiments described herein are not restricted by the architecture of CPU 701 as long as CPU 701 supports the inventive operations as described herein. Bus 702 is coupled to random access memory (RAM) 703, which may be SRAM, DRAM, or SDRAM. ROM 704 is also coupled to bus 702, which may be PROM, EPROM, or EEPROM. RAM 703 and ROM 704 hold user and system data and programs as is well known in the art.

Bus 702 is also coupled to input/output (I/O) controller card 705, communications adapter card 711, user interface card 708, and display card 709. The I/O adapter card 705 connects storage devices 706, such as one or more of a hard drive, a CD drive, a floppy disk drive, a tape drive, to computer system 700. The I/O adapter 705 is also connected to printer 714, which would allow the system to print paper copies of information, such as an output of a repaired circuit design, documents, photographs, articles, etcetera. Note that the printer may be a printer (e.g. dot matrix, laser, etcetera.), a fax machine, scanner, or a copier machine. Communications card 711 is adapted to couple the computer system 700 to a network 712, which may be one or more of a telephone network, a local (LAN) and/or a wide-area (WAN) network, an Ethernet network, and/or the Internet network. User interface card 708 couples user input devices, such as keyboard 713, pointing device 707, etcetera to the computer system 700 to receive various inputs, such as an input of a circuit design or identification of a circuit design like circuit design 620 of FIG. 6. The display card 709 is driven by CPU 701 to control the display on display device 710.

What is claimed is:

1. A method for repairing min-time timing violations comprising:
receiving a circuit design to analyze;
analyzing said circuit design to determine if a min-time timing violation is present in said circuit design; and
fixing a determined min-time timing violation by replacing an appropriate element of said circuit design with a de-raced element.

2. The method of claim 1 wherein said method for repairing is done electronically.

3. The method of claim 1 wherein said step of analyzing to determine if a min-time timing violation is present comprises:
identifying an endpoint associated with said min-time timing violation as a min-time endpoint;
identifying at least one element of said circuit design associated with said min-time endpoint; and
classifying said element associated with said min-time endpoint as a min-time element.

4. The method of claim 1 wherein said step of fixing a determined min-time timing violation comprises:
analyzing an endpoint associated with said min-time timing violation to determine if said analyzed endpoint is a qualifying endpoint wherein said analyzed endpoint is a qualifying endpoint if said analyzed endpoint satisfies a plurality of conditions;
identifying an element that corresponds to said qualifying endpoint as a qualifying element; and
replacing said qualifying element with said de-raced element.

5. The method of claim 4 wherein said plurality of conditions comprises:
a condition that requires an endpoint to be an endpoint for a min-time timing violation;
a condition that requires said endpoint to contain a sufficient time margin so that an insertion of a de-raced element will not introduce a max-time failure; and
a condition that requires said endpoint to not be an endpoint of a circuit element that contains properties such that no other circuit element satisfies said properties.

6. The method of claim 4 wherein said de-raced element exhibits a functionality similar to a functionality of said qualifying element.

7. The method of claim 4 wherein said de-raced element includes a delay element selectively arranged for said timing violation.

8. The method of claim 7 wherein said delay element delays signals at one or more of:
an input data point of said de-raced state element;
an enable point of said de-raced state element; and
a reset point of said de-raced state element.

9. The method of claim 4 wherein said de-raced element occupies an area that is similar to an area occupied by said qualifying element that is being replaced.

10. The method of claim 4 wherein said qualifying element is a state element.

11. The method of claim 1 wherein said de-raced element comprises:
a state element; and
a delay element integrated into said state element.

12. The method of claim 11 wherein said state element comprises one or more of:
a latch; and
a flip-flop.

13. The method of claim 4 wherein said qualifying element that is being replaced comprises one or more of:
a latch; and
a flip-flop.

14. The method of claim 4 further comprising the step of:
identifying an element that does not correspond to said qualifying endpoint as non-qualifying element.

15. The method of claim 14 further comprising the step of:
identifying a min-time timing violation associated with said non-qualifying element as a remaining min-time timing violation; and
repairing said remaining min-time timing violation.

16. The method of claim 15 wherein said step of repairing said remaining min-time timing violation comprises:
implementing at least one additional independent delay element into said circuit design.

17. The method of claim 16 wherein said independent delay element comprises:
a delay buffer.

18. A system for repairing violations, said system comprising:
a means for analyzing a circuit for the presence of at least one timing violation;
a means for identifying an element to replace with a de-raced element to repair said timing violation; and
a means for replacing said identified element with said de-raced element.

19. The system of claim 18 wherein said means for identifying an element comprises:
a means for identifying an endpoint associated with said timing violation; and
a means for identifying an element associated with said endpoint.

20. The system of claim 18 further comprising;
a means for classifying an endpoint as a qualifying endpoint if:
said endpoint is an endpoint corresponding to a min-time timing violation,
said endpoint contains a sufficient time margin so that an insertion of a de-raced element will not introduce a new max-time violation, and
said endpoint does not correspond to an element that comprises characteristics such that another element can not satisfy said characteristics of said element.

21. The system of claim 20 wherein said means for identifying an element further comprises:
a means for classifying said element corresponding to said qualifying endpoint as a qualifying element.

22. The system of claim 18 wherein said means for replacing said identified element further comprises:
a means for replacing a qualifying element with said de-raced element wherein said de-raced element comprises:
a replacement element that exhibits the same functionality as the qualifying state element and a delay element integrated therewith.

23. The system of claim 22 wherein said de-raced state element is configured so that it occupies an area similar to an area occupied by said qualifying element that is being replaced.

24. A computer program product having a computer readable medium having computer program logic recorded thereon for repairing timing violations, the computer program product comprising:
code for analyzing a circuit for the presence of at least one timing violation;
code for identifying at least one endpoint corresponding to said timing violation; and
code for identifying at least one circuit element associated with said endpoint wherein said element can be replaced to repair said timing violation.

25. The computer program product of claim 24 further comprising:
code for replacing said element with said de-raced element.

26. The computer program product of claim 25 further comprising:
code for outputting a repaired circuit.

27. The computer program product of claim 25 wherein said de-raced element comprises:
a delay element; and
an element exhibiting the same functionality as said element to be replaced.

28. The computer program product of claim 27 wherein said code for replacing said element with said de-raced element further comprises:
code for selectively arranging said delay element according to said timing violation.

29. The computer program product of claim 24 further comprising:
code for identifying said endpoint associated with a min-time violation as a min-time endpoint.

30. The computer program product of claim 24 wherein said code for identifying at least one circuit element comprises:
code for identifying an element associated with a min-time endpoint as a min-time element.

31. The computer program product of claim 29 further comprising:
code for analyzing said min-time endpoint to determine if said min-time endpoint is a qualifying endpoint wherein said min-time endpoint is a qualifying endpoint if said min-time endpoint satisfies a plurality of conditions; and
code for identifying an element that corresponds to said qualifying endpoint as a qualifying element.

32. The computer program product of claim 31 wherein said plurality of conditions comprises:
a condition that requires an endpoint to be an endpoint for a min-time violation, and
a condition that requires said endpoint to contain a sufficient time margin so that an insertion of a de-raced element will not introduce a max-time failure.

33. The computer program product of claim 32 wherein said plurality of conditions further comprises:
a condition that requires said endpoint to not be an endpoint of a circuit element that contains properties such that no other circuit element satisfies said properties.

34. The computer program product of claim 31 wherein said code for replacing said element comprises:
code for replacing said qualifying element with said de-raced element.

35. The computer program product of claim 27 further comprising:
code for placing said delay element of said de-raced element at one or more of:
an input data point of said de-raced state element;
an enable point of said de-raced state element; and
a reset point of said de-raced state element.

36. The computer program product of claim 31 further comprising:
code for identifying an element that does not correspond to a qualifying endpoint as a non-qualifying element.

37. The computer program product of claim 36 further comprising:
code for identifying a timing violation associated with said non-qualifying element as a remaining timing violation; and
code for repairing said remaining timing violation.

38. The computer program product of claim 37 wherein said code for repairing said remaining timing violation further comprises:
code for integrating at least one new independent delay element into said circuit to fix said remaining timing violation.
